(19) United States
(12) Patent Application Publication
(10) Pub. No.: US 2024/0304344 A1
(43) Pub. Date: Sep. 12, 2024

(54) NUCLEAR REACTOR WITH LIQUID HEAT TRANSFER AND SOLID FUEL ASSEMBLIES, INTEGRATING A NOMINAL POWER EVACUATION SYSTEM WITH A LIQUID METAL BATH AND MATERIAL(S) (MCP) FOR THE EVACUATION OF RESIDUAL POWER IN THE EVENT OF AN ACCIDENT

(71) Applicant: COMMISSARIAT A L'ENERGIE ATOMIQUE ET AUX ENERGIES ALTERNATIVES, Paris (FR)

(72) Inventors: Alessandro PANTANO, Saint Paul Lez Durance (FR); Vincent PASCAL, Saint Paul Lez Durance (FR); Philippe AMPHOUX, Saint Paul Lez Durance (FR); Pierre ALLEGRE, Saint Paul Lez Durance (FR); Christoph DODERLEIN, Saint Paul Lez Durance (FR); Pierre SCIORA, Saint Paul Lez Durance (FR)

(73) Assignee: COMMISSARIAT A L'ENERGIE ATOMIQUE ET AUX ENERGIES ALTERNATIVES, Paris (FR)

(21) Appl. No.: 18/593,478

(22) Filed: Mar. 1, 2024

(30) Foreign Application Priority Data
Mar. 1, 2023 (FR) 23 01898

(51) Int. Cl. G21C 1/03; G21C 15/18; G21C 15/247; G21C 15/26

(52) U.S. Cl. CPC G21C 1/03; G21C 15/182; G21C 15/247; G21C 15/26

(57) ABSTRACT

A nuclear reactor with forced-convection liquid coolant and solid fuel assemblies incorporates a heat removal system using a liquid metal bath for removing the nominal heat and phase-change material(s) (PCM) for removing the decay heat in an accident situation. The solid-fuel nuclear reactor with liquid metal or molten salt primary coolant simultaneously ensures heat removal by forced convection in the primary circuit, in normal and accident operating modes, during shutdown through the primary vessel of the reactor, that is, beyond the second containment barrier. In the event of an incident or accident, a compact passive decay heat removal system is capable of performing the safety function for a predetermined period, typically three days, without any intervention by an operator, due to the presence of one or more PCM(s) that store(s) the decay heat produced in the core and removed by the primary vessel.

### TECHNICAL FIELD

The present invention relates to the field of solid-fuel nuclear reactors cooled with one or more molten salt(s) or liquid metal coolant(s), in particular with liquid sodium, referred to as fast neutron reactors (FNR), which are part of the Generation IV family of nuclear reactors.

More particularly, the invention relates to a simplification of the architecture of these nuclear reactors while ensuring reliable removal of both the nominal heat and the decay heat in normal and accident shutdown situations.

The invention applies to small modular reactors (SMR), and more specifically to micro modular reactors (MMR), typically with an operating power of less than 20 MWth.

It will be recalled here that the decay heat of a nuclear reactor is the heat produced by the core after the nuclear chain reaction has been shut down and which consists mainly of the energy of the decay of the fission products. The decay heat corresponds to a fraction of the nominal heat and decreases over time. In any event, it must be taken into account during the normal reactor shutdown phases, during handling phases, and also during accident situations, in order to size heat removal systems.

Although the invention is described with reference to a nuclear reactor cooled with one or more molten salt(s), it also applies to reactors cooled with liquid sodium or any other liquid metal, such as lead, used as a coolant in a nuclear reactor primary circuit.

Likewise, although the invention is described with reference to a fast neutron reactor, it also applies to thermal and/or epithermal spectrum reactors.

### Prior Art

The fast neutron reactor system was developed to allow improved management of the nuclear fuel, in particular through sustainable management of the plutonium stock and the ability to recover the stock of isotope 238 of uranium, which isotope cannot be recovered in thermal neutron reactors.

The uranium-plutonium breeding cycle is only possible with high-energy neutrons. The resulting fast neutron spectrum is the key to the sustainable management of the plutonium stock and to the possibility of recovering stocks of uranium-238 not used by the more conventional system of light-water cooled thermal neutron reactors.

Solid-fuel fast neutron reactors are based on a physical separation between the solid fuel and the coolant, by means of a barrel forming a physical barrier (cladding). The fuel itself is made up of materials that are solid at the target operating temperatures (in particular in the form of oxides, silicon carbides (SIC) or nitrides of fissile materials, or directly in the form of a metal alloy).

Operationally, the physical barrier separating the fuel and the coolant makes it possible to:
act as a containment barrier in the sense of the safety function of controlling the containment of the radioactive materials, in particular the containment of the gaseous fission products generated,
implement a different technical configuration and management provisions for the fuel and the coolant.

In this context, the main solid-fuel fast neutron reactor projects were developed around concepts implementing liquid metals or gases to perform the coolant function, and with a solid fuel physically separated from the coolant by a barrier.

Mention can be made of FNRs cooled with liquid sodium or lead, or high-temperature gas-cooled reactors.

The system of FNRs cooled with sodium (Na) is the most mature technology, in particular integral reactors, that is, with a primary sodium circuit positioned inside the reactor vessel. The feedback derived from the operation of a number of FNR-Na reactors both in France and abroad [1] has highlighted the following advantages:
improved use of the nuclear fuel, that is, a reduction in waste per unit of energy produced, which is valid for all fast neutron reactors;
improved thermodynamic efficiency of approximately 42% compared with pressurized water reactors, for which it is of the order of 32-33%, due to a higher mean coolant temperature of up to 550° C. at the reactor core outlet;
very efficient heat transfer and cooling of the fuel due to the use of a liquid metal with very high thermal conductivity;
significant natural convention in the primary circuit, which contributes to decay heat removal (DHR) in accident situations;
the absence of pressurization of the coolant in the primary circuit, due to its fairly large operating range in the liquid state at ambient pressure of approximately 100° C. to 880° C.

However, integral FNR-Na reactors have the following drawbacks:
a risk of exothermic reaction in the event of interaction between the sodium and water or air, which requires:
   strict control of the quantity of oxygen in the liquid sodium loops, together with stringent sealing requirements;
   having an additional secondary sodium loop compared to pressurized water reactors between the primary circuit and the energy conversion system, in order to separate the radiological risk and the chemical risk;
risks of the primary sodium boiling in the event of a loss of flow or loss of cooling accident without activation of the reactor emergency shutdown devices, which, with safety margins, limits the operating temperature to 550° C. at the core outlet.

Lead-cooled reactors (FNR-Pb) make it possible to eliminate the risks linked to the exothermic interaction between sodium and water and to produce high-temperature heat by means of a solid fuel, while increasing the coolant boiling margin, as the boiling temperature of lead is approximately 1,750° C.

Nevertheless, lead-cooled reactors have problems of erosion/corrosion of the components, which are worse at high temperatures and with very high coolant densities, which requires them to operate at temperatures limited to 500-550° C.: [2].

Two other known reactor technologies are intrinsically capable of overcoming or at the very least attenuating the risks linked to the exothermic reaction between sodium and water and the boiling of the coolant in the event of an accident, and of producing high-temperature heat (>550° C.) by means of a solid fuel.

These are gas-cooled fast reactors (GFR), very high temperature gas reactors (VHTGR) and solid-fuel reactors cooled with a molten salt, referred to as MSFR.

VHTGRs are characterized by solid fuel the very high thermal inertia, low power density and very high melting temperature of which improve safety compared to sodium reactors. Reference can be made to FR2956773B1 or publication [3]. A pressurized gas is used to cool the fuel, which makes it possible to avoid the risks linked to a liquid coolant boiling in the event of an accident. In addition, using a gas makes it possible to go up to very high temperatures provided that the structural materials are compatible, typically up to 1,000° C. at the core outlet, and to achieve significant efficiency levels. Among the gases that have been considered as coolants, helium has often been selected as the main candidate due to its thermal properties (greater conductivity and specific heat than other gases) and its chemical inertia.

However, having a gas (helium) as the coolant involves the following different drawbacks:
the low power density of the fuel requires an increase in the volume of the primary vessel that contains the nuclear fuel;
in order to increase the heat transfer of the gas and the efficiency of the facility, pressurization of the primary circuit is necessary. This requires large dimensions of the primary vessel, that is, an increase in its wall thickness;
helium is a complicated fluid to use as it can penetrate solid barriers three times more easily than air [4]. A loss of helium stock must therefore be considered during the operation of a VHTGR;
to date, helium is a material that is not very abundant on Earth and the cost of which is high [5];
there is an operating risk linked to the depressurization of the primary circuit.

In order to overcome the problems resulting from the use of a liquid metal or a gas as a coolant, a liquid salt can be used as a coolant.

A very compact nuclear reactor architecture using a liquid salt as a coolant, with low power of approximately 120 MWth, is described in publication [6], and mainly illustrated in FIG. 1 of said publication.

This architecture of a liquid salt-cooled solid-fuel reactor solves all of the problems linked to the use of helium set out above. Although the operating temperature mentioned in publication [6] is approximately 500-550° C., the boiling/dissociation temperature of the salt is sufficiently high (>1,000° C.) to make it possible to operate at higher temperatures without any risk of boiling.

However, the reactor architecture according to publication [6] has the following drawbacks:
the presence of an intermediate circuit within the primary vessel of the reactor, which involves:
   the need to have feedthroughs in the closure above the primary vessel and additional requirements linked to the sealing of the boiler;
   a risk of entrainment of gas bubbles into the core which, when it is a fast neutron spectrum core, can lead to a power peak;
   potential activation of the intermediate fluid;
   a larger vessel size;
   decreased overall reliability due to the addition of components and systems and due to a more complex configuration;
   more complex, and therefore longer and/or more costly constructability;
a redan structure inside the primary vessel that must allow the installation of an intermediate heat exchanger between the primary salt circuit and secondary salt circuit, which probably complicates the manufacturing thereof; and more generally, irreplaceable primary vessel internals subject to regulatory constraints regarding manufacturability and inspection and that can have an impact on the service life of the facility due to their irreplaceable nature;
the downward flow zone of the coolant salt in the primary vessel, usually called the “downcomer”, must be sufficiently large to allow the insertion of an intermediate heat exchanger. The heat exchanger is necessarily a large component because a liquid salt is a poor coolant with very low thermal conductivity, typically of the order to 0.5 to 1 W/mK, compared to liquid metals such as sodium, which has a conductivity of approximately 60 W/mK. However, a large primary vessel is more difficult to manufacture in a factory and to transport;
the absence of dedicated decay heat removal (DHR) safety systems in the event of an accident;
the fuel handling takes place by removing the reactor closure in an inert atmosphere, which requires significant facility shutdown times, and checks on the sealing of the reactor before restarting.

There is therefore a need to improve solid-fuel nuclear reactors cooled using liquid metal or liquid salt(s), in particular in order to overcome the aforementioned drawbacks.

In general, there is a need to improve the safety of solid-fuel nuclear reactors cooled using liquid metal or liquid salt(s), by complying with all of the points of specifications that can be defined as follows:
operation with forced convection in the primary circuit in power ranges between 20 and 100 MWth depending on the operating mode,
DHR function guaranteed by a preferably compact passive system,
simplification of the internal structures of the primary vessel compared to the known vessels,
limiting of the feedthroughs of the primary vessel,
overall simplification of the heat removal function during normal reactor operation,
operation at atmospheric pressure without a chemical risk of exothermic interaction with water and air,
radiological protection as close as possible to the nuclear materials, performing the third containment barrier function.

The aim of the invention is to at least partly meet this need/these needs.

### DESCRIPTION OF THE INVENTION

In order to achieve this, the invention relates, in one of its aspects, to a nuclear reactor cooled using liquid metal or one or more molten salt(s), comprising:
a vessel, referred to as the primary vessel, axisymmetric about a central axis (X), filled with a first coolant using at least one liquid metal or at least one inert liquid salt as the coolant of the primary circuit of the reactor, comprising:
   a core made up of assemblies containing nuclear fuel materials in the solid state, contained in at least one barrel;
   at least one pump for circulating the first coolant;
   a structure forming a redan, with a central axis coincident with the axis of the primary vessel, the structure being arranged in the primary vessel so as to separate the inside thereof into a central zone and a peripheral zone so that during the operation of the reactor, the pump(s) make(s) the liquid metal or molten salt coolant circulate by forced convection in a loop from the bottom of the central zone in which is arranged the reactor core inside which the fission reactions occur, from where it rises by heating to the top of the central zone, where it is diverted towards the top of the peripheral zone, to descend towards the bottom of the peripheral zone, where it is diverted towards the core of the reactor;
a vessel referred to as the secondary vessel, arranged around the primary vessel;
a reactor pit, arranged around the secondary vessel;
a reactor closure, to enclose the first coolant inside the primary vessel;
a system for removing the heat both during nominal operation and in situations in which the nuclear reactor is shut down, the system comprising:
   a shell arranged between the primary vessel and the secondary vessel, defining a volume with the primary vessel filled with liquid metal;
   a closed circuit, referred to as the secondary circuit, filled with a second coolant and capable of removing the heat itself removed by conduction through the primary vessel and transferred by the liquid metal, to an energy conversion system and/or a heat network;
a system for removing the decay heat (DHR) in accident situations of the nuclear reactor, the system comprising:
   at least one solid-liquid phase-change material (PCM) arranged inside the space delimited between the shell and the secondary vessel, the PCM(s) being capable of melting while storing by latent heat at least some, preferably all, of the decay heat emitted by the core in accident situations, for a predetermined duration.

Advantageously, the stock of PCM(s) makes it possible, due to the energy required for the phase change (latent heat) to absorb all of the decay heat from the core for a predetermined duration of three days. There is therefore a sizing margin linked to the sensible heat of the molten salt in the liquid state that would make it possible, well before it boiled, to absorb additional decay heat and therefore leave a grace period before intervention of more than three days.

“Sensible heat” is given to mean the heat that the material, in a given state, can absorb without changing phase.

Here and in the context of the invention, “shutdown situations” is given to mean a normal reactor shutdown and not a reactor shutdown in the event of an accident (accident situations).

“Inert liquid salt” is given to mean a liquid salt coolant that does not comprise any fissionable elements or breeder elements and does not react chemically with water or air.

According to one advantageous embodiment, the circulation pump(s) is(are) (a) centrifugal pump(s) arranged vertically and mounted as (a) feedthrough(s) of the core head plug of the primary vessel with its (their) blades arranged above the redan.

Advantageously, the height of PCM(s) between the shell and the secondary vessel is greater than the height of inert liquid salt(s) between the primary vessel and the shell. This ensures that the leaking of liquid salt coolant through the primary vessel is limited or prevented in the event of an accident. Likewise, preferably, the height of the liquid metal between the primary vessel and the shell is greater than the height of inert liquid salt(s) between the primary vessel and the shell.

According to one advantageous structural variant, the primary and second vessels and the shell are right cylinders arranged concentrically.

Preferably, the inert liquid salt is selected from chlorine-based salts, optionally enriched with chlorine-37 to reduce the formation of radioactive Cl36, more preferably NaCl, KCl, MgCl₂, CaCl₂), ZnCl₂ or a mixture thereof, in particular a molten salt mixture NaCl—MgCl2, NaCl—MgCl2-KCl or NaCl—MgCl2-KCl—ZnCl₂.

According to one advantageous variant embodiment, the closed circuit comprises a serpentine coil, the periphery of which is preferably provided with heat dissipating fins, the serpentine coil being arranged between the primary vessel and the shell, in a spiral around the shell. Preferably, the serpentine coil can be fixed, in particular by welding to the shell.

The liquid metal of the bath between the primary vessel and the shell consists of pure aluminium.

Preferably, the PCM(s) between the shell and the secondary vessel is/are in the form of a powder.

More preferably, the PCM(s) between the shell and the secondary vessel is/are made from pure aluminium.

More preferably, the primary vessel is made from AISI 316L stainless steel, or a nickel-based alloy, or silicon carbide (SiC).

More preferably, the secondary vessel and the shell are made from AISI 316L stainless steel, or a nickel-based alloy, or silicon carbide (SiC), depending on the planned operating conditions.

The nuclear reactor according to the invention can be a thermal spectrum, epithermal spectrum or fast neutron reactor.

According to a first alternative, the primary vessel is thus devoid of moderating material so that the reactor operates using fast neutrons.

According to a second alternative, the reactor core houses at least one moderating material so that the reactor operates using thermal neutrons or epithermal neutrons. The coolant can advantageously act as the moderator (chloride salt containing lithium, or fluoride salt).

In the context of the invention, “moderating material” is given to mean any material that makes it possible to slow the neutrons. In the usual sense, the kinetic energy of a fast neutron is greater than 1 eV, while the kinetic energy of a thermal neutron is less than 1 eV, typically of the order of 0.025 eV. Reference can be made to publication [8], and particularly to FIG. 4, which shows the thermal fraction and the fast fraction of the neutron flux for several types of reactor.

Reference can be made to FR3025650B1, which describes the insertion of moderating materials into a fuel assembly of a fast neutron reactor.

According to one advantageous embodiment, the solid nuclear fuels are nuclear fuel assemblies and/or fuel particles, referred to as TRISO, and/or fuel pellets individually housed in separate cells of a plate.

The solid nuclear fuels can be based on depleted, low enriched, preferably with enrichment of <5%, or reprocessed (URT) uranium dioxide (UO₂), and/or on plutonium dioxide (PuO₂), or based on enriched uranium U²³⁵ (HALEU, or high-assay low-enriched uranium), preferably with enrichment of between 5% and 20%.

Preferably, the nuclear reactor comprises a reactivity control system made up either of control rods inside the primary vessel, or by rotating drums outside the primary vessel.

The nuclear reactor described above is particularly intended to have a power of between 20 and 100 MWth.

The invention therefore essentially consists of producing a solid-fuel nuclear reactor using liquid metal or molten salt primary vessel coolant that simultaneously ensures:
heat removal by forced convection in the primary circuit, in normal and accident operating modes, during shutdown through the primary vessel of the reactor, that is, beyond the second containment barrier;
in the event of an incident or accident, the implementation of a passive decay heat removal system that is compact and capable of performing the safety function for a predetermined period, typically three days, without any intervention by an operator, due to the presence of one or more PCM(s) that store(s) the decay heat produced in the core and removed by the primary vessel;
a drastic reduction in the risk of gas entrainment into the core, due to the absence of an intermediate heat exchanger within the primary vessel;
the simplification of the architecture of the primary circuit, the reactor pit and the reactor vessel without any feedthroughs, with a heat removal fluid circuit, which:
   improves the reliability and inspectability thereof,
   allows the replacement of the primary components, which considerably increases the overall service life of the facility,
   simplifies the constructability thereof,
   helps to simplify the demonstration of safety and therefore make it more robust,
   simplifies all of the maintenance and handling operations, in particular fuel handling;
a extremely simplified second barrier without a singular point, which comes solely from the limits of the primary vessel,
due to the location of the heat exchanger, made up of the closed circuit, on the outside of the primary vessel, the possibility of performing maintenance and inspection operations in a simplified manner, beyond the second containment barrier.

Some of the many advantages of the invention are:
operation with active flow, i.e. by forced convection, of the coolant in the primary circuit for reactors with a thermal power of 20 to a few tens of MWth, typically up to 100 MWth, in normal/nominal operation and/or for decay heat removal, by reduction of the pressure drops due to the absence of an intermediate heat exchanger within the primary vessel;
improved safety as the feedthroughs of the second containment barrier (primary vessel) are limited to the reactivity control devices, that is, to the control rod feedthroughs, and to the circulation pumps of the primary which are feedthroughs in the upper part of the primary vessel, through the closure, and therefore above the liquid volume of the primary fluid, and to the usual instrumentation devices. Vessel reactivity control devices, for example in the form of neutron reflectors rotating about the primary vessel, can also be envisaged on the outside of the primary vessel to further reduce the closure feedthroughs;
simplification of the design of the primary vessel due to the absence of feedthroughs for heat removal, which limits the singular points and makes it possible to increase the service life of the vessel;
simplification of the structure forming the redan in terms of mechanical support and hydraulics as, unlike in the solutions of the prior art, it no longer needs to incorporate intermediate heat exchangers;
the elimination of an intermediate circuit;
a wider choice of fluid in the closed secondary circuit and therefore a wider choice of energy recovery methods, due to the removal of heat beyond the second barrier (primary vessel). For example, a pressurized fluid (gas or supercritical CO₂) can be envisaged without the risk of having to take into account the consequences of the entrainment of a gas bubble into the reactor core in the demonstration of safety.

The preferred applications of the invention are small reactors in the Gen IV family, in particular reactors cooled using sodium, lead or liquid salt.

Further advantages and features of the invention will become more clearly apparent on reading the detailed description of exemplary embodiments of the invention given by way of non-limiting illustration, with reference to the following figures.

### BRIEF DESCRIPTION OF THE DRAWINGS

FIG. 1 is a schematic transverse cross-sectional view of a liquid salt-cooled nuclear reactor according to the invention, with a system for removing nominal and decay heat in the event of a shutdown through the primary vessel and a system for removing decay heat in accident situations.

FIG. 2 is a detailed view of FIG. 1.

FIG. 3 is a longitudinal cross-sectional perspective view of a nuclear reactor according to the invention.

FIG. 4 is a detailed view of FIG. 3 according to a variant embodiment of the secondary closed circuit of the reactor.

### DETAILED DESCRIPTION

Throughout the present application, the terms “vertical”, “lower”, “upper”, “bottom”, “top”, “below” and “above” are to be understood with reference to a primary vessel filled with inert liquid salt of a fast neutron nuclear reactor according to the invention, in its vertical operating configuration.

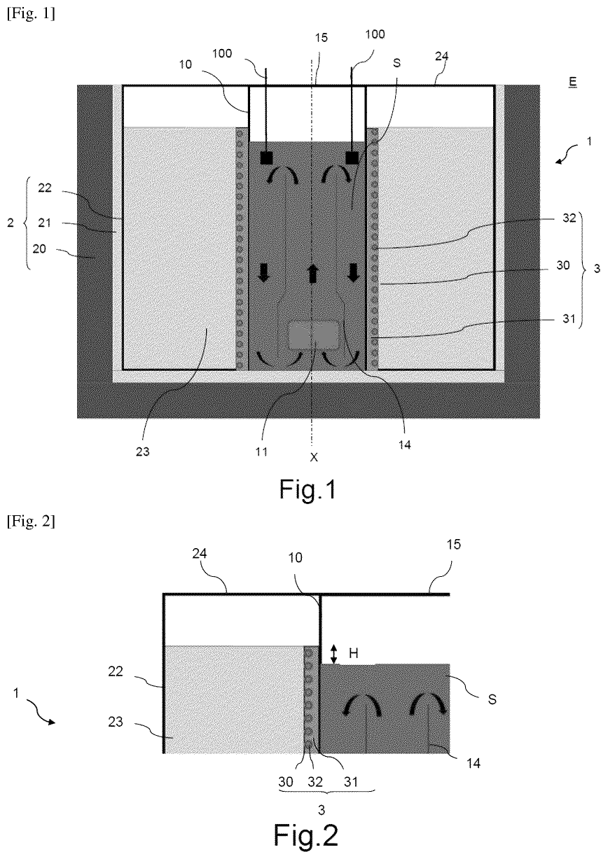

FIGS. 1 to 4 show a liquid salt-cooled fast neutron nuclear reactor 1 according to the invention.

Such a reactor 1 comprises a primary vessel 10 or reactor vessel, filled with inert liquid salt, referred to as primary salt S, and which houses the core 11 in which are immersed a plurality of fuel assemblies, not shown, which generate thermal energy through nuclear fission of the fuel.

The inert liquid salt S is therefore the coolant of the primary circuit: it stores and transports the heat from the core 11 and exchanges heat through the wall of the primary vessel 10. The primary salt is provided with physical and chemical properties that make it possible to ensure that it remains in a liquid state at atmospheric pressure in the normal and accident operating temperature range of the core 11. It is inert from a radioactive point of view, as it does not contain any breeder elements or fissionable elements, and it is also chemically inert vis-à-vis the PCMs and liquid metal bath described in detail hereinafter, and vis-à-vis all of the structures of the reactor.

The primary salt S is selected so that it has good thermal and physical properties to promote natural convection and heat exchanges with the core 11 and through the wall of the primary vessel 10.

The primary salt is thus advantageously selected from NaCl, KCl, MgCl2, CaCl2 or ZnCl2 enriched with chlorine-37 or a mixture thereof, in particular a molten salt mixture NaCl-MgCl2, NaCl—MgCl2-KCl or NaCl—MgCl2-KCl—ZnCl2. For example, NaCl—KCl—MgCl2, which has a melting point of less than 500° C., good thermal capacity (Cp) and a good thermal expansion coefficient, is advantageous for improving natural convection.

The solid nuclear fuels can be based on depleted, low enriched, preferably with enrichment of <5%, or reprocessed (URT) uranium dioxide, and/or on plutonium dioxide (PuO₂), or based on enriched uranium U235 (HALEU, or high-assay low-enriched uranium), preferably between 5% and 20% enriched.

The fuel assemblies can comprise SiC fuel cladding, in order to withstand very high temperatures. The claddings of the fuel assemblies form the first containment barrier while the vessel 10 forms the second containment barrier for the radioactive materials contained in the core 11.

The primary vessel 10 supports the weight of the liquid salt of the primary circuit and the internals.

The core 11 is supported by a welded structure referred to as the diagrid 12 in which the feet of the fuel assemblies 11 are positioned.

The core 11 is surrounded by a separating barrel 13 provided with a peripheral neutron reflector intended to ensure that the neutron flux is retained in the core. This separating barrel 13 of the core 11 makes it possible to separate the cold and hot primary salt. The cold primary salt thus surrounds the core 11 inside the primary vessel, while the hot primary salt, heated by circulating upwards in the core 11, is in the upper central portion of the core.

Typically, the diagrid 12 is made from AISI 316L stainless steel, or a nickel-based alloy, or silicon carbide (SiC), depending on the operating conditions.

As shown, the primary vessel 10 is a right cylinder with a central axis X. Typically, the primary vessel 10 is made from AISI 316L stainless steel, preferably with a very low boron content in order to guard against the risk of cracking at high temperature. Its external surface is preferably rendered highly emissive by a pre-oxidation treatment, which is carried out in order to facilitate the radiation of heat to the outside during the decay heat removal phase. The primary vessel 10 can also be made from or a nickel-based alloy, or silicon carbide (SiC), depending on the operating conditions.

The reactor vessel 10 comprises pumps 100 for circulating the inert liquid salt as primary coolant.

The reactor vessel 10 is divided into two distinct zones by a separating structure made up of at least one shell 14 arranged inside the reactor vessel 10. This separating device is also known as a redan.

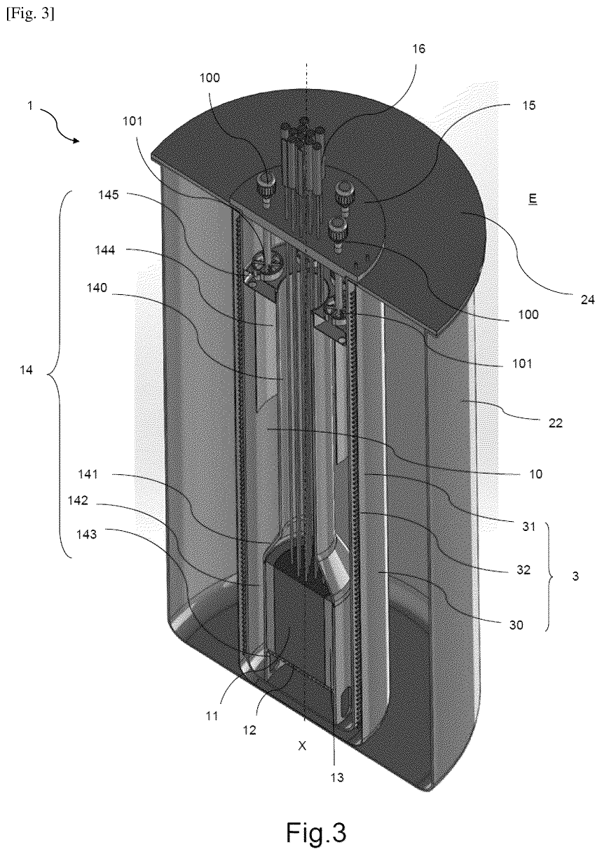

As illustrated in FIG. 3, the redan 14 with a central axis X can comprise three shells 140, 141, 142 welded to each other, namely:
the top shell 140, in the form of a right cylinder;
the central shell 141, in the form of a frustum;
the bottom shell 142 which surrounds the separating barrel 13, in the form of a right cylinder.

The redan 14, and more specifically its bottom shell 142, can be welded to the diagrid 12 as shown in FIG. 3, and is placed on and welded to the bottom of the primary vessel 10.

The redan 14 further comprises through-openings 143 made through the bottom shell 142.

As shown by the arrows in FIG. 1, the redan 14 is arranged in the primary vessel 10 so that it forms a central chimney to separate the inside of the primary vessel 10 into a central zone and a peripheral zone so that during the operation of the reactor, the pumps 100 make the liquid-metal or molten-salt coolant circulate by forced convection, in a loop from the bottom of the central zone in which is arranged the reactor core 11, from where it rises by heating to the top of the central zone, where it is diverted towards the top of the peripheral zone to descend towards the bottom of the peripheral zone, where it is diverted towards the core 11.

Typically, the redan 14 is made from AISI 316L stainless steel, or a nickel-based alloy, or silicon carbide (SiC), depending on the operating conditions.

Advantageously, as shown in FIG. 3, the redan 14 can comprise, in its top part, a deflector 144 and a section reducer 145 which are each arranged around the top shell 140 to reduce the flow area for the inert liquid salt S in the peripheral zone when it descends towards the bottom. This makes it possible to increase the speed of the liquid salt S, in particular in this downwards flow zone, which is usually referred to as the “downcomer”. It also makes it possible to advantageously improve the heat transfer by convection from the salt S to the wall of the primary vessel 10.

The central chimney form of the redan 14 improves the circulation by natural convection of the liquid salt S.

A removable plug 15 referred to as the core head plug is arranged directly above the core 11 and closes the primary vessel 10 in order to contain the liquid salt S, act as a barrier between the liquid salt S and the external environment, and also form, with the primary vessel, the second containment barrier for the materials contained in the core 11.

Like the primary vessel 10, the core head plug 15 is chemically inert vis-à-vis the PCMs and liquid metal bath described in detail hereinafter, and vis-à-vis all of the structures of the reactor.

The core head plug 15 is provided with feedthroughs for the components of the control rods 16 and for the elements for controlling and monitoring the core 11 and the stock of liquid salt S, not shown.

The core head plug 15 is therefore a plug that can be removed in an inert atmosphere and which carries all of the handling systems and all of the instrumentation necessary for monitoring the core and comprising the control rods, the number of which depends on the type of core and the power thereof, as well as the thermocouples and other monitoring devices. A system for maintaining the temperature of the plug will be provided in order to limit the risks of deposits of salt aerosols.

Typically, the core head plug 15 is made from AISI 316L stainless steel, or a nickel-based alloy, or silicon carbide (SiC), depending on the operating conditions. Also typically, the material used for the control rods is B4C.

In one variant, instead of the control rods, rotating drums, also made from B4C, can be arranged outside the primary vessel 10, so as to advantageously eliminate the feedthroughs of the plug 15 and therefore the risks of seizing associated with the salt aerosols.

As shown in FIG. 3, the pumps 100 for circulating the primary salt are preferably centrifugal pumps arranged vertically and mounted as feedthroughs of the core head plug 15 of the primary vessel, with their blades 101 arranged above the redan 14.

The reactor vessel 10 comprises a plenum, usually referred to as cover gas plenum, filled with an inert gas, such as argon or helium, above the molten salt liquid fuel. This plenum makes it possible to absorb the thermal expansion of the liquid within the reactor vessel, when it undergoes a change in level, and to recover the gaseous fission products generated by the nuclear fission within the fuel.

A support, containment and thermal insulation assembly between the primary vessel and the external environment E is arranged around the primary vessel 10.

More specifically, as shown in FIGS. 1 and 3, this assembly 2 comprises a reactor pit 20, into which are inserted, from the outside towards the inside, a layer of thermally insulating material 21, a secondary vessel 22 and the primary vessel 10 of the reactor.

The reactor pit 20 is a block with a generally cylindrical external shape that supports the weight of all of the components inside it. The reactor pit 20 has the functions of providing biological protection and protection against external attack, and also of providing cooling of the external environment in order to maintain low temperatures. Typically, the reactor pit 20 is a block of concrete.

The layer of thermally insulating material 21 ensures the thermal insulation of the reactor pit 20. Typically, the layer 21 is made of a polyurethane or silicate-based foam.

The secondary vessel 22 ensures that the liquid salt S is retained in the event of a leak from the primary vessel 10 and protects the reactor pit 20. The secondary vessel 22 also contains a volume 23 of solid-liquid phase-change material(s) (PCM).

The volume 23 of PCM(s), preferably in the form of powder, is capable of melting while storing by latent heat at least part of the decay heat emitted by the core in accident situations, for a predetermined duration. The physical and chemical properties of the PCM(s) thus make it possible to ensure that it/they remain in the solid state at atmospheric pressure in the normal operating temperature range of the core and that they change phase when the core 11 enters an accident situation, for a predetermined duration.

As shown in FIG. 2, the stock of the total volume 23 of PCM(s) makes it possible to ensure a height H greater than the height of the inert liquid salt S in the primary vessel 10. Such a height helps to retain all of the primary salt S inside the primary vessel 10 in the event of a leak in the wall thereof.

The PCM(s) is/are chemically inert vis-à-vis the liquid metal bath and all of the structures of the reactor.

Typically, the PCM is made from pure aluminium. As a variant, the metal PCM can be replaced by a salt PCM, for example MgCl2.

The secondary vessel 22 bears against the reactor pit 20 and its top part is welded to the reactor closure 17.

Typically, the secondary vessel 22 can be made from AISI 316L stainless steel, or a nickel-based alloy, or silicon carbide (SiC), depending on the operating conditions.

An annular removable closure 24 around the core head plug 15 closes the secondary vessel 22 in order to contain the volume 23 of PCM(s) and act as a barrier between this volume 23 and the external environment E.

Like the secondary vessel 22, the closure 24 is chemically inert vis-à-vis the PCMs and liquid metal bath described in detail hereinafter, and vis-à-vis all of the structures of the reactor.

The closure 24 is provided with feedthroughs for the elements for controlling and monitoring the stock of PCM(s), not shown, and meets the sealing requirements of the second containment barrier. In the handling phase, the operations requiring the removal of this closure must take place in an inert atmosphere.

Typically, the closure 24 can be made from AISI 316L stainless steel, or a nickel-based alloy, or silicon carbide (SiC), depending on the operating conditions.

The nuclear reactor 1 further comprises a system 3 for removing the heat both during nominal operation and in situations in which the nuclear reactor is shut down.

This system 3 firstly comprises a cylindrical shell 30 arranged concentrically between the primary vessel 10 and the secondary vessel 22.

This shell 30 thus defines a volume with the primary vessel 10 filled with a liquid metal bath 31.

Typically, the shell 30 can be made from AISI 316 stainless steel, or a nickel-based alloy, or silicon carbide (SiC), depending on the operating conditions, and is designed to chemically and mechanically withstand the liquid metal bath 31 and the volume of PCM 23.

A closed circuit 32, referred to as the secondary circuit, is filled with a coolant and is capable of removing the heat removed by conduction through the primary vessel 10 and transferred by the liquid metal bath 31, to an energy conversion system and/or a heat network, not shown.

The liquid metal bath 31 thus improves the heat transfer by conduction from the primary vessel 10 to the secondary circuit 32.

Typically, the liquid metal bath is made from pure aluminium.

The liquid metal is chemically inert vis-à-vis the liquid salt S, the PCMs and all of the structures of the reactor.

The closed circuit 32 is preferably made up of a serpentine coil arranged in a spiral around the primary vessel 10, preferably welded to the inner wall of the shell 30.

The serpentine coil 32 has a diameter that depends on the diameter of the primary vessel 10 and a height that is sufficient to have the surface area necessary for the heat removal sought.

In other words, the total number of turns, the spacing and the diameter of these turns that make up the serpentine coil 32 are dependent on the diameter of the primary vessel 10 and on the power of the nuclear reactor core 11. For example, the pitch of the turns of the serpentine coil 32 can be equal to 10 cm, which is a good compromise between manufacture and conductive heat absorption by the liquid metal bath.

Again for example, the outer diameter of the serpentine coil 32 is of the order of 5 to 10 cm with a turn pitch of the order of 10 to 15 cm, so as to minimize pressure drops, reduce the footprint of the pipes and maximize the surface area exposed to the primary vessel 10. The thickness of the serpentine coil 32 depends on the mechanical stresses applied by the internal liquid metal and by its weight.

The material of the serpentine coil 32 must have good emissivity properties. Typically, the material of the serpentine coil is selected from AISI 316L stainless steel, ferritic steels, and nickel-based alloys. This material depends on the internal fluid used in the closed circuit 32.

This internal coolant that circulates in the serpentine coil 32 is a chemically stable, low viscosity liquid metal that is a good conductor and carrier of heat, chemically compatible with all of the pipework of the circuit 3 and able to operate in natural or forced convection in a temperature interval of 150-600° C. Typically, the liquid metal of the circuit 3 can be selected from an NaK alloy, a Pb—Bi alloy, sodium or one of the ternary alloys of the liquid metals, etc.

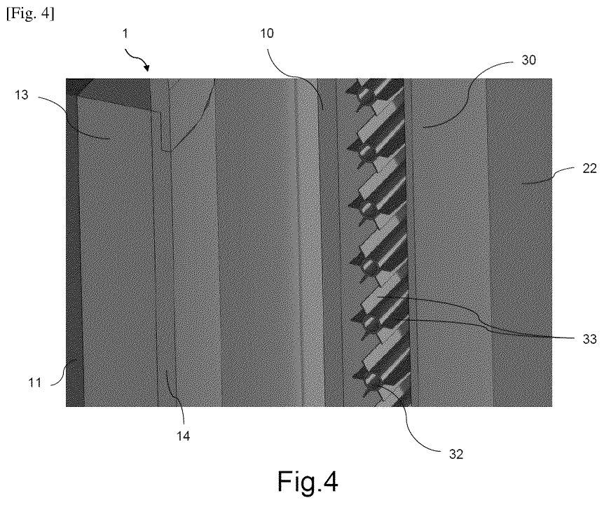

In order to improve the heat exchange between the liquid metal bath 31 and the pipe forming the serpentine coil 32, the serpentine coil can be provided with heat dissipating fins 33, in particular with a straight shape, that extend radially from the pipe, as shown in FIG. 4.

The operation of the nuclear reactor 1 will now be described with respect to the different normal, planned shutdown and accident situations.

During normal operation of the reactor, all of the heat generated by the fission reactions of the core 11 is removed by heat exchange when the salt S in the liquid state, which is in forced convection by virtue of the pumps 100, passes through the core. The liquid salt S exchanges this heat through the wall of the primary vessel 10 when it falls back down between the redan 14 and the primary vessel 10. This heat is then transferred by the liquid metal bath 31 to be removed by the secondary circuit 32 to a heat network and/or an energy conversion system. During normal operation, the volume 23 of PCM remains in the solid state.

In the event of a planned shutdown caused by an operator, the same heat exchanges take place. The decay heat from the shut down core 11 is also removed by heat exchange when the inert salt S in the liquid state passes through the core 11. Then, the salt S exchanges this heat through the wall of the primary vessel 10 when it falls back down between the redan 14 and the primary vessel 10. This heat is then transferred by the liquid metal bath 31 to be removed by the secondary circuit 32 to a heat network and/or an energy conversion system. During this planned shutdown, the volume 23 of PCM remains in the solid state.

During operation in an accident situation, in particular in the event of a station blackout (SBO), which corresponds to a complete loss of electrical power supply, as in the Fukushima accident, the decay heat from the shut down core 11 is removed by heat exchange when the salt S in the liquid state passes through the core. Then, the salt S exchanges this heat through the wall of the primary vessel 10 when it falls back down between the redan 14 and the primary vessel 10. This heat is absorbed by the initially solid PCM, which undergoes a transition from the solid state to the liquid state. The stock of the volume 23 of PCM makes it possible, due to the energy required for the phase change (latent heat) to absorb all of the decay heat from the core for a predetermined duration, typically three days.

The inventors have conducted sizing studies to demonstrate the feasibility of a nuclear reactor 1 as described above, and to propose orders of magnitude relating to its characteristic elements.

The studies conducted cover the 20 to 100 MWth range in normal and accident operation, with circulation of the primary salt S solely by forced convection by means of the pumps 100.

The cold temperature of the inert liquid salt S, as the primary fluid, is set at 600° C.

The hydraulic path of the salt S is determined by the analytical study shown in the tables below.

The thermal power range is defined within which the nuclear reactor 1 is intended to operate solely by forced convection by way of the pumps 100, but without heat exchangers within the primary vessel.

The relevant properties are summarized in Table 1 below.

TABLE 1

| Properties/input data | Unit | Value |
|---|---|---|
| Nominal thermal power of the | MWth | between 20 and 100 |
| reactor 1 | | |
| Height of the primary vessel 10 | m | 20 |
| Diameter of the primary vessel 10 | m | 1.6 |
| Width of the annular space between | m | 0.063 |
| redan 14 and primary vessel 10 | | |
| Inlet temperature of the core 11 | ° C. | 600 |
| Equivalent diameter of the core 11 | m | 1 m |
| in line with the deflector 144 | | |
| Type of primary salt S | — | NaCl—KCl—MgCl2 |
| | | in respective proportions |
| | | of 30-20-50 |

It will be noted here that the properties of the salt in question are as set out in publication [11].

These input data, for a variable power of between 20 and 100 MWth, were used by the inventors for the preliminary calculations using thermal calculation software such as COPERNIC: [9], [10].

These sizing calculations were carried out according to two sequential steps, as follows.

Step 1/: a core configuration is selected with the lowest possible resistance with respect to thermal hydraulics. A first core sizing is necessary to calculate the total pressure drops of the primary hydraulic circuit.

Step 2/: a flow of the primary salt S solely by forced convection within the primary vessel 10 and a heat transfer that takes place solely by forced convection through the wall of the primary vessel 10.

In step 1/, a preliminary core design with nuclear fuel pin assemblies was determined for a power interval of 20 to 100 MWth. In this calculation, the hydraulic flow area was maximized by applying the physical quantities given in Table 2.

TABLE 2

| Physical quantities of the core 11 | Unit | Value |
|---|---|---|
| Distance between the fuel pins | mm | 3.08 |
| Diameter of the core 11 | m | 1 |
| Linear thermal power | W/cm | ~100 |
| Equivalent height of a pin | m | 2 |
| Outer diameter of a pin | mm | 6.55 |
| Thickness of fuel cladding | mm | 0.45 |

Taking into account the physical quantities in Table 2, the hydraulic flow area for the salt S is maximized by fissile height values of the fuel and a number of fuel pins in the core. Having a maximized hydraulic flow area improves the flow of the fluid as the greater the area for a given flow rate, the more the core pressure drops are reduced.

The preliminary sizing calculations for the core 11 are summarized in Table 3, for thermal powers of 30, 40 and 100 MWth respectively.

It will be noted that the fuel assemblies in question have hexagonal sheaths.

TABLE 3

| Physical quantities of | | | | |
|---|---|---|---|---|
| the core 11 | Unit | Value | | |
| Nominal thermal power | MWth | 30 | 40 | 100 |
| Linear thermal power | W/cm | 102.02 | 100 | 163.38 |
| Height of the core 11 | mm | 400 | 522.81 | 800 |
| Equivalent height of a pin | m | 2 | 2 | 2 |
| Outer diameter of a pin | mm | 6.55 | 6.55 | 6.55 |
| Central hole diameter of a | mm | 0 | 0 | 0 |
| pin | | | | |
| Distance between the fuel | mm | 3.08 | 3.08 | 3.08 |
| pins | | | | |
| Heating of the salt S | ° C. | 54.49 | 63.95 | 114.8 |
| within an assembly | | | | |
| Number of pins | — | 7651 | 7651 | 7651 |
| Inner diameter of cladding | mm | 5.65 | 5.65 | 5.65 |
| Outer diameter of a fuel | mm | 5.42 | 5.42 | 5.42 |
| pellet | | | | |
| Temperature at the centre | ° C. | 1814.05 | 1771.31 | 2293.05 |
| of a fuel pellet | | | | |
| Speed of the salt S | m/s | 0.66 | 0.72 | 1.02 |
| Pressure drop within a | bar | 0.06 | 0.07 | 0.12 |
| bundle | | | | |
| Area occupied by the core | m² | 0.75 | 0.78 | 0.78 |
| 11 | | | | |
| Equivalent diameter | m | 1 | 1 | 1 |
| Hydraulic area of the core | m² | 0.489 | 0.509 | 0.509 |
| 11 | | | | |
| Height/diameter ratio of the | — | 0.409 | 0.524 | 0.802 |
| core 11 | | | | |
| Fissile volume of the core | m³ | 0.068 | 0.092 | 0.141 |
| 11 | | | | |

The results of Table 3 give the input data for the sizing calculation of the primary circuit. This determines the temperature difference at the inner wall of the primary vessel 10 necessary to remove the heat carried by the primary salt S.

Table 4 below shows the results of operating calculations for the reactor on the basis of the calculations above. It is specified that the speed of the salt in the annular space has been multiplied by a factor of 5 with respect to that derived from circulation solely by natural convection.

TABLE 4

| Operating conditions | Unit | Value | | |
|---|---|---|---|---|
| Nominal thermal power | MWth | 30 | 40 | 100 |
| Flow area | m² | 0.51 | 0.51 | 0.51 |
| ΔT between the outlet and the | ° C. | 54.50 | 63.95 | 114.80 |
| inlet of the core | | | | |
| Inlet temperature of the core 11 | ° C. | 600 | 600 | 600 |
| Outlet temperature of the core 11 | ° C. | 654.50 | 663.95 | 714.80 |
| Total height of the core 11 | m | 2 | 2 | 2 |
| Pressure change in the core 11 | bar | 0.022 | 0.025 | 0.045 |
| Diameter of the core 11 with | m | 1.47 | 1.47 | 1.47 |
| redan 14 | | | | |
| Boiler diameter | m | 1.6 | 1.6 | 1.6 |
| Thickness of annular space | m | 0.063 | 0.063 | 0.063 |
| (between redan 14 and | | | | |
| primary vessel 10) | | | | |
| Hydraulic area of the annular space | m² | 0.30 | 0.30 | 0.30 |
| Hydraulic diameter of the annular | m | 0.19 | 0.19 | 0.191 |
| space | | | | |
| Height of the annular space | m | 20 | 20 | 20 |
| Speed of the salt S in the annular | m/s | 4.95 | 5.63 | 7.89 |
| space | | | | |
| ΔT salt S/inner wall of primary | ° C. | 56.73 | 67.62 | 126.30 |
| vessel 10 | | | | |
| Pressure drop in the annular space | bar | 0.30 | 0.38 | 0.68 |
| Total pressure drop | bar | 0.32 | 0.40 | 0.72 |
| Mean temperature of the annular | ° C. | 627.25 | 631.97 | 657.40 |
| space | | | | |

It can be seen from the results of Table 4 that an increase in the speed of the salt contributes to a marked improvement in the heat transfer coefficient between salt S and vessel wall.

Compared to an architecture by natural convection, a forced-convection architecture according to the invention has the following advantages:
a reduction in the temperature difference between salt S and wall which involves an increase in the temperature of the fluid at the outlet of the heat exchanger in the form of a serpentine coil 32 to approximately 600° C., and therefore in the electrical efficiency of the electric conversion system connected to the heat exchanger;
a potential reduction in the height of the primary vessel to 15 m or even 10 m, from a fixed height of 20 m in the calculations to promote solely natural circulation of the salt S.

The invention is not limited to the examples that have just been described; features of the illustrated examples can in particular be combined together within variants that are not illustrated.

Further variants and embodiments can be envisaged without departing from the scope of the invention.

### LIST OF CITED REFERENCES

[1]: H. OHSHIMA et al., “Handbook of Generation IV Nuclear Reactors”, chapter 5, Elsevier, 2016.
[2]: M. TARANTINO et al., “Overview on Lead-Cooled Fast Reactor Design and Related Technologies Development in ENEA”, MDPI Energies. vol. 14, p. 5157, 2021.
[3]: M. A. FUTTERER et al., “Status of the very high temperature reactor system”, Progress in Nuclear Energy, vol. 77, pp. 266-281, 2014.
[4]: GLENN D. CONSIDINE ed., “Van Nostrand's Encyclopedia of Chemistry”, Wiley-Interscience, 5th edition, 2005.
[5]: A. H. O. H. U. Sverdrup, “Assessing the Past and Future Sustainability of Global Helium”, Biophysical Economics and Sustainability (2020), 2020.
[6]: L. LIN et al., “Feasibility of an innovative long-life molten chloride-cooled reactor”, Nuclear Science and Techniques, vol. 33, pp. 1-15, 2020.
[7]: http://sme.vimaru.edu.vn/sites/sme.vimaru.edu.vn/files/volume_2_-_properties_and_selection_nonf.pdf
[8]: Jiri Krepel et al. “Self-Sustaining Breeding in Advanced Reactors: Characterization of Selected Reactors”, Encyclopedia of Nuclear Energy 2021, Pages 801-819. https://www.sciencedirect.com/science/article/pii/B9780128197257001239?via%3Dihub
[9]: F. MORIN et al., “COPERNIC, A NEW TOOL BASED ON SIMPLIFIED CALCULATION METHODS FOR INNOVATIVE LWRs CONCEPTUAL DESIGN STUDIES”, ICAPP 2017 Conference, 2017.
[10]: P. GAUTHE et al., “Innovative and inherently safe small SFR as a response to the dilemma ‘safety vs cost’”, ICAPP 2019 Conference, 2019.
[11]: Y. LI et al., “Survey and evaluation of equations for thermophysical properties of binary/ternary eutectic salts from NaCl, KCl, MgCl2, CaCl2, ZnCl2 for heat transfer and thermal storage fluids in CSP”, Solar Energy, vol. 152, pages 57-79, 2017.

1. A nuclear reactor cooled by liquid metal or one or more molten salt(s), comprising:
a primary vessel axisymmetric about a central axis and filled with a first coolant using at least one liquid metal or at least one inert liquid salt as a coolant of a primary circuit of the reactor, comprising:
a core made up of assemblies containing nuclear fuel materials in the solid state, contained in at least one barrel;
at least one pump for circulating the first coolant;
a structure forming a redan, with a central axis coincident with the central axis of the primary vessel, the structure being arranged in the primary vessel so as to separate an inside thereof into a central zone and a peripheral zone so that during operation of the reactor, the pump(s) make(s) the liquid metal or molten salt coolant circulate by forced convection, in a loop from a bottom of the central zone in which is arranged the reactor core inside which fission reactions occur, from where the liquid metal or molten salt coolant rises by heating to a top of the central zone, is diverted towards the top of the peripheral zone to descend towards the bottom of the peripheral zone, and is diverted towards the core of the reactor,
a secondary vessel arranged around the primary vessel;
a reactor pit arranged around the secondary vessel;
a core head plug configured to enclose the first coolant inside the primary vessel;
a system for removing the heat both during nominal operation and in situations in which the nuclear reactor is shut down, comprising:
a shell arranged between the primary vessel and the secondary vessel, defining a volume with the primary vessel filled with liquid metal; and
a closed secondary circuit filled with a second coolant and capable of removing the heat itself removed by conduction through the primary vessel and transferred by the liquid metal, to an energy conversion system and/or a heat network;
a system for removing decay heat in accident situations of the nuclear reactor, comprising:
at least one solid-liquid phase-change material (PCM) arranged inside a space delimited between the shell and the secondary vessel, the PCM(s) being capable of melting while storing by latent heat at least some of the decay heat emitted by the core in accident situations, for a predetermined duration.

2. The nuclear reactor according to claim 1, wherein the circulation pump(s) is (are) centrifugal pumps arranged vertically and mounted as feedthroughs of the core head plug of the primary vessel having blades arranged above the redan.

3. The nuclear reactor according to claim 1, wherein a height of PCM(s) between the shell and the secondary vessel is greater than a height of inert liquid salt(s) between the primary vessel and the shell.

4. The nuclear reactor according to claim 1, wherein the primary and second vessels and the shell are right cylinders arranged concentrically with each other.

5. The nuclear reactor according to claim 1, wherein the inert liquid salt is selected from chlorine-based salt.

6. The nuclear reactor according to claim 1, wherein the closed circuit comprises a serpentine coil arranged between the primary vessel and the shell, in a spiral around the shell.

7. The nuclear reactor according to claim 1, wherein the liquid metal of a bath between the primary vessel and the shell consists of pure aluminium.

8. The nuclear reactor according to claim 1, wherein the PCM(s) between the shell and the secondary vessel is/are in the form of a powder.

9. The nuclear reactor according to claim 1, wherein the PCM(s) between the shell and the secondary vessel is/are made from pure aluminium.

10. The nuclear reactor according to claim 1, wherein the primary vessel is made from AISI 316L stainless steel, or a nickel-based alloy, or silicon carbide (SiC).

11. The nuclear reactor according to claim 1, wherein the secondary vessel and the shell are each made from AISI 316L stainless steel, or a nickel-based alloy, or silicon carbide (SiC).

12. The nuclear reactor according to claim 1, wherein the primary vessel is devoid of moderating material so that the reactor operates using fast neutrons.

13. The nuclear reactor according to claim 1, wherein the reactor core houses at least one moderating material so that the reactor operates using thermal neutrons or epithermal neutrons.

14. The nuclear reactor according to claim 1, wherein the solid nuclear fuels are nuclear fuel assemblies and/or fuel particles, and/or fuel pellets individually housed in separate cells of a plate.

15. The nuclear reactor according to claim 1, wherein the solid nuclear fuels are based on depleted, low enriched, or reprocessed (URT) uranium dioxide (UO₂), and/or on plutonium dioxide (PuO₂), or based on enriched uranium U235 (HALEU, or high-assay low-enriched uranium).

16. The nuclear reactor according to claim 1, comprising a reactivity control system made up either of control rods inside the primary vessel, or by rotating drums outside the primary vessel.

17. The nuclear reactor according to claim 1, the power of which is between 20 and 100 MWth.

18. The nuclear reactor according to claim 5, wherein the chlorine-based salts comprise NaCl, KCl, MgCl₂, CaCl₂, ZnCl₂ or a mixture thereof.

19. The nuclear reactor according to claim 6, wherein the serpentine coil has a periphery provided with heat dissipating fins.
